(19) United States
(12) Patent Application Publication
(10) Pub. No.: US 2003/0181224 A1
(43) Pub. Date: Sep. 25, 2003

(54) Method for dialing a phone number

(75) Inventors: Chih-Jung Peng, Taipei (TW); Yuan-Chia Tung, Taipei (TW)

Correspondence Address: NIXON PEABODY, LLP, 8180 GREENSBORO DRIVE, SUITE 800, MCLEAN, VA, 22102, US

(73) Assignee: SILITEK CORPORATION, Taipei (TW)

(21) Appl. No.: 10/287,701

(22) Filed: Nov. 5, 2002

(30) Foreign Application Priority Data
Mar. 25, 2002 (TW) 091105719

(51) Int. Cl. H04B 1/38

(52) U.S. Cl. 455/565; 455/566; 455/564

(57) ABSTRACT

The method for dialing a phone number and operating an electronic device with single hand includes the following steps. The electronic device displays a virtual keyboard on the screen. Then, the user operates virtual keyboard by activating the selection function of the jog device to select a desired key value. After selecting the desired key value, the user operates the input function of the jog device to input the key value. After the edit process of dialing the phone number is completed, the user operates the input function of the jog device to dial the phone number out.

### CROSS REFERENCE TO RELATED APPLICATIONS

This Application claims priority to Taiwan Patent Application No. 091105719 entitled “Method for Dialing A Phone Number”, filed Mar. 25, 2002

### FIELD OF INVENTION

The invention relates to a method for dialing a phone number, and more specifically, to an input method for dialing a phone number through a portable electronic device.

### BACKGROUND OF THE INVENTION

When the number of the users of portable computers and personal digital assistants (PDAs) increases in recent years, the market of cellular phones expands rapidly as well. Therefore, it is feasible for the users to transfer information outdoors or in any desired places if one may connect the portable computer to the cellular phone.

For the above purpose, the current trend for the mobile products is either combining the cellular phone with PDA function or combining the PDA with the mobile communication function. This type of product is known as “mobile communication device”.

The mobile communication devices are capable of providing conventional phone functions, sending or receiving email and fax, and connecting to the internet in any places. A device of this kind generally includes a display unit larger than that in a conventional cellular phone. In order to reduce the size, there is a virtual keyboard on the screen of the device to provide the input function for the device.

In general, a user of mobile communication devices inputs and dials a phone number by using a stylus or retrieves the phone number pre-stored in the device. However, operating this kind of combination device as a phone needs both hands, one hand for holding it and the other hand for controlling the stylus to select the phone number prestored or to input the phone number.

Moreover, a mobile communication device of the prior art has many operation units or optional modules, such as a stylus. These modules result in the increase of cost and the operation difficulty, not to mention the low possibility of size reduction.

### SUMMARY OF THE INVENTION

One aspect of the exemplary embodiments of the present invention is to provide an input method to input characters using a jog device of an electronic device.

Another aspect of the exemplary embodiments of the present invention is to easily make dialing action using single hand through a mobile communication device, such as a PDA.

The method of dialing a phone number through an electronic device with single hand includes the following steps. The electronic device displays a virtual keyboard which at least includes digits ‘0˜9’ and characters ‘#’, ‘*’, and so on over a screen. The user then selects a key value he wants on the virtual keyboard by activating the selection function of the jog device. After the key value is selected, the user inputs the key value by activating the input function of the jog device. The edit process is completed after the dialed digits are all input. After the edit process is completed, the dial-out operation is executed by activating the input function of the jog device.

### BRIEF DESCRIPTION OF THE DRAWINGS

FIG. 1 is a front view of an electronic device.

FIG. 2 is a side view of an electronic device.

FIG. 3 is a flow chart of an exemplary method of the present invention.

FIG. 4 is a diagram of an exemplary embodiment of a PDA.

FIG. 5 is a diagram of another exemplary embodiment of a PDA.

### DETAILED DESCRIPTION

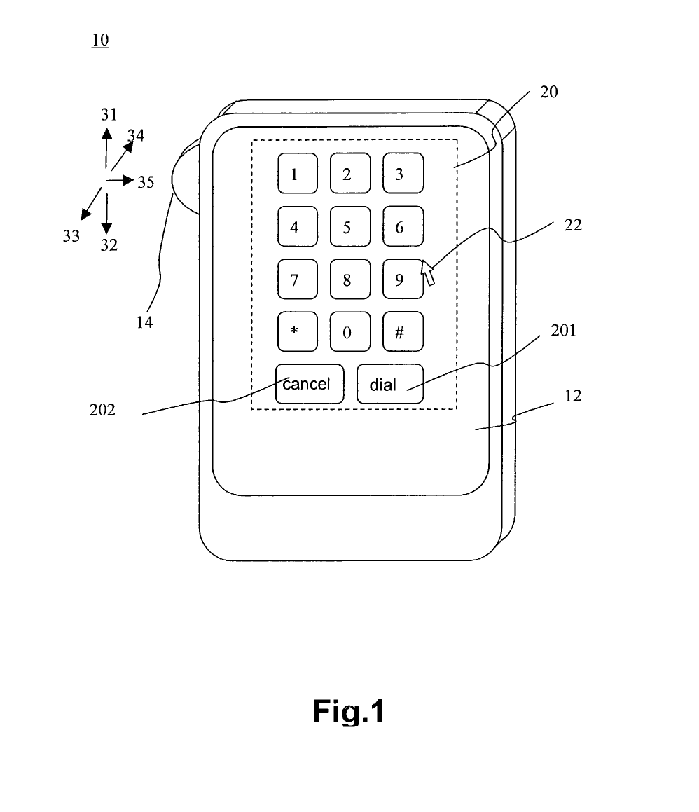

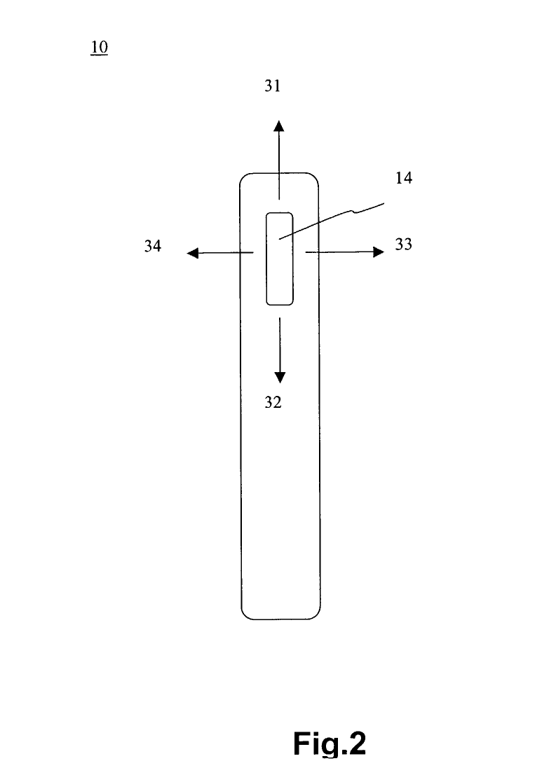

As shown in FIG. 1 and FIG. 2, an exemplary electronic device 10 includes a screen 12 and a jog device 14. The jog device 14 has a selection function and an input function. The selection function is used to move the cursor 22 or a cursor-like mark to a desired location on the screen 12. By pressing the jog device toward a combination direction of the first direction 31, the second direction 32, the third direction 33, and/or the fourth direction 34 allows one to move the cursor 22 to the desired location over the virtual keyboard. The input function is executed by pressing the jog device 14 toward the fifth direction 35.

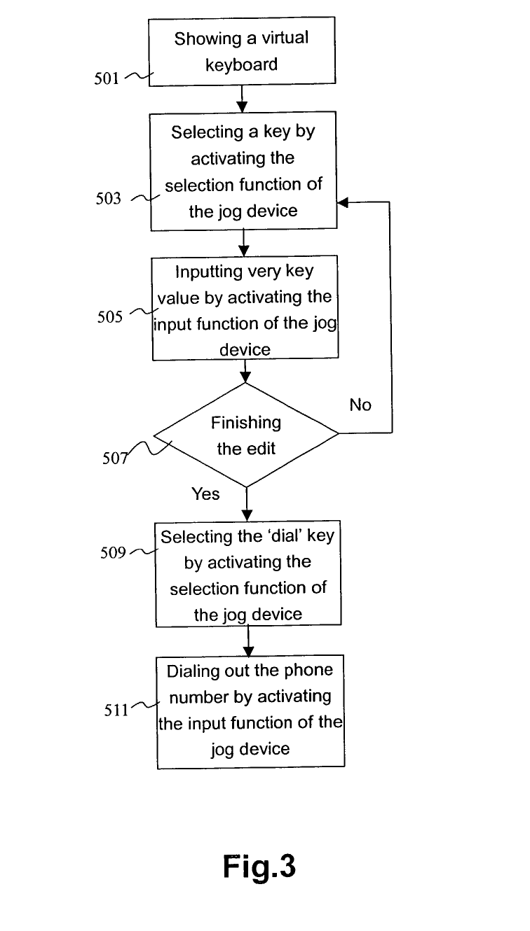

As shown in FIG. 3, the exemplary method of the invention includes the following steps. In the step 501, a virtual keyboard 20 is displayed on the screen 12 of the electronic device 10. The virtual keyboard 20 at least includes digits ‘0˜9’, characters ‘#’ and ‘*’, and two basic function keys, ‘dial’ 201 and ‘cancel’ 202.

In the step 503, the user activates the selection function of the jog device 14 to drive the jog device 14 selectively in the first direction 31, the second direction 32, the third direction 33, or the fourth direction 34, so as to make the cursor 22 move to the desired key location over the virtual keyboard 20.

In the step 505, the user activates the input function of the jog device 14 by pressing the jog device 14 toward the fifth direction 35 to input the key value selected. In the step 507, the user repeats the step 503 and 505 if the dialed phone number is not completely edited yet.

In the step 509, the user selects the ‘dial’ key by activating the selection function of the jog device 14 after the edit of the phone number is completed. In the step 511, the user activates the input function of the jog device 14 to effect the dialing action.

Generally speaking, the electronic device 10 may be a personal digital assistant (PDA) with phone function or a mobile communication device.

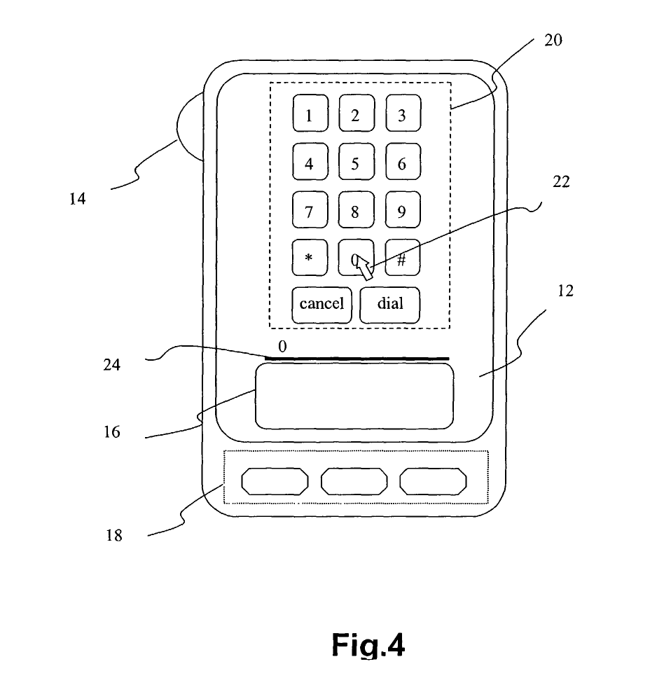

For example, a personal digital assistant with phone function, as shown in FIG. 4, includes a screen 12, a jog device 14, a stylus input zone 16, and a key zone 18. When the user attempts to dial a phone number, the PDA is caused to enter a phone dialing system. The screen 12 displays a virtual keyboard 20 which at least has digits ‘0˜9’, characters ‘#’ and ‘*’, and two basic function keys, ‘dial’ and ‘cancel’.

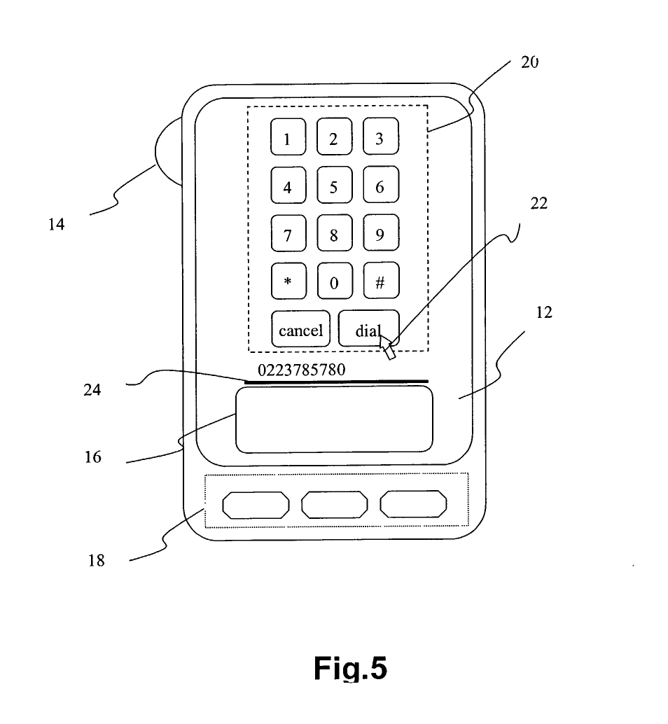

Next, the user moves the cursor 22 to the desired key location by operating the jog device 14. For example, the cursor 22 is moved onto the key ‘0’ if ‘0’ is to be selected. ‘0’ will show on the top of the input line 24 in the lower zone of the screen 12 after the user presses the jog device 14 toward the fifth direction 35. Following the similar steps, all digits of the phone number are edited successively. After the edit process is completed, the user moves the cursor 22 to the key ‘dial’, as shown in FIG. 5, and then presses the jog device 14 toward the direction 35. The entire dialing action is then concluded. If error occurs during the input of the phone number, the user can correct it with the key ‘cancel’.

It is noted that single hand is required to dial a phone number by the method of the present invention. Other auxiliary tools, i.e. a stylus and an external keyboard, are unnecessary.

Those skilled in the art will readily observe that numerous modifications and alterations of the device may be made while retaining the teaching of the invention. Accordingly, the above disclosure should be construed as limited only by the bounds of the claims.

1. A method for dialing a phone number by using a jog device of an electronic device, the electronic device comprising a screen, the jog device having a selection function and an input function, which comprising:
(1.1) displaying a virtual keyboard on the screen;
(1.2) editing the phone number by operating the virtual keyboard with the jog device;
(1.3) dialing the phone number.

2. The method of claim 1, wherein the step of (1.2) further comprises:
(2.1) operating the selection function of the jog device to select keys over the virtual keyboard corresponding to the phone number;
(2.2) inputting key values corresponding to the keys by activating the input function of the jog device;
(2.3) repeating the steps of (2.1) and (2.2) until an edit of the phone number is complete, and then proceeding the step of (1.3).

3. The method of claim 1, wherein the step of (1.3) is performed by activating the input function of the jog device.

4. The method of claim 1, wherein the electronic device is a personal digital assistant (PDA).

5. The method of claim 1, wherein the electronic device is a mobile communication device.

6. A method for dialing a phone number by using a jog device of an electronic device, the electronic device comprising a screen, the jog device having a selection function and an input function, which comprising:
(6.1) displaying a virtual keyboard on the screen;
(6.1) operating the selection function of the jog device to select keys over the virtual keyboard corresponding to the phone number;
(6.3) inputting key values corresponding to the keys by activating the input function of the jog device;
(6.4) repeating the steps of (6.2) and (6.3) until an edit of the phone number is complete, and then proceeding the step of (6.5);
(6.5) dialing the phone number.

7. The method of claim 6, wherein the electronic device is a personal digital assistant.

8. The method of claim 6, wherein the electronic device is a mobile communication device.
